(19) United States
(12) Patent Application Publication
(10) Pub. No.: US 2011/0106958 A1
(43) Pub. Date: May 5, 2011

(54) Method and system for providing wireless services

(75) Inventors: Robin J. Thompson, Batavia, IL (US); Donna M. Sand, Redmond, WA (US)

(73) Assignee: Alcatel-Lucent USA Inc.

(21) Appl. No.: 12/588,851

(22) Filed: Oct. 30, 2009

(51) Int. Cl. G06F 15/16

(52) U.S. Cl. 709/230

(57) ABSTRACT

Example embodiments are directed to a system for providing wireless services to a first user on the system after a handoff from a first mobile switching center to a second mobile switching center. The system includes a first application server configured to provide wireless services and coupled to the second mobile switching center. The second mobile switching center serves the first user. A second application server is configured to provide wireline services and interact with the second application server to provide the wireless and wireline services to the first user.

### BACKGROUND

IP Multimedia Subsystem (IMS) was developed by 3^{rd} Generation Partnership Project (3GPP) to provide multimedia services using Internet Protocol (IP). IMS is based on a wireline model, in which case users of the IMS must be pre-provisioned as users on the IMS before they are allowed basic access.

A Femto base station is a low cost and low power base station transceiver which is generally installed indoors (e.g., in a home or office) and connected to the Internet via cable, DSL, on-premise fiber optic link or a similar IP backhaul technology. This connection is used to integrate the Femto base station with the wireless operator's core network.

The Femto base station serves a geographic area known as a Femto cell over a single carrier or channel. When a Femto cell user travels outside of the Femto cell, a handoff (HO) occurs between the Femto cell and another cell. For example, when a user travels from the office to an area outside the office, a call originating from a Femto cell in the office is usually handed-off from the Femto cell to a code division multiple access (CDMA) macro cell.

Handoff of a CDMA user from a Femto cell to a CDMA macro cell is achieved via 3GPP2 inter-mobile switching center (MSC) mobile application part (MAP) signaling messages. In 3GPP2 inter-MSC call handoff, the original MSC (anchor MSC) remains as a control point switch. Thus, the original MSC provides supplementary services and call control for the handed-off call.

The new MSC (target MSC) provides a CDMA cell connection and translates signals from a mobile device, including supplementary services signals, to inter-MSC MAP messages which are sent to the anchor MSC.

Session Initiation Protocol (SIP) is used to signal for control of supplementary services for a CDMA user on an IMS based Femto cell. However, there is no defined interworking of inter-MSC MAP signaling and SIP messages to allow the IMS to provide supplementary services to a user that has been handed-off out of the Femto cell into the CDMA macro cell, which does not support SIP signaling for supplementary services control.

Therefore, supplementary services for the CDMA user are prevented after handoff. A theoretical solution requires implementation of a SIP client on a CDMA handset. The theoretical solution is generally known as IMS Centralized Services (ICS).

In ICS, the supplementary services are provided by SIP signaling via a non-call associated signaling path (e.g., short message service (SMS) messaging) to an IMS telephony application server (TAS). The TAS is part of the anchor MSC. However, the TAS has been developed for wireline services and does not have a wireless network interface for user services (subscriber services) data retrieval. Moreover, the ICS solution requires the CDMA handset to be modified to include a SIP client. Also, the CDMA handset and the TAS must be configured to communicate via the non-call associated signaling path.

### SUMMARY

Example embodiments provide systems and methods for adding mobility network services in an IMS.

An example embodiment discloses a system for providing wireless services to a first user on the system after a handoff from a first mobile switching center to a second mobile switching center. The system includes a first application server configured to provide wireless services and coupled to the second mobile switching center. The second mobile switching center serves the first user. A second application server is configured to provide wireline services and interact with the second application server to provide the wireless and wireline services to the first user.

Another example embodiment discloses a method of providing wireless services to a first user on a system after a handoff from a first mobile switching center to a second mobile switching center. The method includes first receiving, at a first application server, a call request from the first mobile switching center. The call request is initiated by a third user during an existing call between the first user and a second user. An invite to answer the call request is transmitted, by the first application server, to a second application server. A first protocol message is received from the second application server. The first protocol message is based on the invite. A second protocol message is transmitted by the first application server to the first user. The second protocol is different than the first protocol.

Another example embodiment discloses a method of providing wireless services to a first user on a system after a handoff from a first mobile switching center to a second mobile switching center. The method includes receiving a first protocol message including a call request from the second mobile switching center during an existing call between the first user and a second user. The call request is initiated by the first user. A second protocol message including the call request is transmitted to a second application server. The second protocol is different than the first protocol. The first application server receives a second protocol acknowledgment message from the second application server. The second protocol acknowledgment message indicates that that the second user is on hold. The first application server transmits a second first protocol message to the second application server. The second first protocol message includes an identification of a third user to be connected to the first user.

### BRIEF DESCRIPTION OF THE DRAWINGS

Example embodiments will be more clearly understood from the following detailed description taken in conjunction with the accompanying drawings. FIGS. 1-4F represent non-limiting, example embodiments as described herein.

FIG. 1 illustrates a telecommunications system including an IMS network according to an example embodiment;

FIGS. 2A-2D illustrate an example embodiment of a method of controlling a TAS and a Mobile Application Part, (MAP) Femto Interworking Function (MFIF) in a call process in an IMS;

FIGS. 3A-3C illustrate another example embodiment of a method of controlling a TAS and a MFIF in a call process in an IMS; and

FIGS. 4A-4F illustrate an example embodiment of a method of controlling a MFIF and a TAS in an IMS during three way calling.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, e.g., “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements or control nodes (e.g., a scheduler located at a base station or Node B). Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. Example embodiments are not limited by these aspects of any given implementation.

As used herein, the term “user equipment” (UE) may be synonymous to a mobile user, mobile station, user, subscriber, wireless terminal and/or remote station and may describe a remote user of wireless resources in a wireless communication network. The term “base station” may be understood as a one or more base stations, access points, and/or any terminus of radio frequency communication. Although current network architectures may consider a distinction between mobile/user devices and access points/base stations, the example embodiments described hereafter may generally be applicable to architectures where that distinction is not so clear, such as ad hoc and/or mesh network architectures, for example.

Example embodiments provide systems and methods for adding mobility network services in an IMS. SIP services control signals to and from a TAS are interworked with 3GPP2 MAP standard signaling messages to and from a HO target MSC. The mobility network services may be used while continuing to use wireline telephony applications for more complicated operations such as mid-call features that use call path reconfiguration (e.g., call waiting, three-way calling, and call transfer applications).

Wireless user services may be provided in an IMS. The wireless user services may be provided in an IMS based dual mode (CDMA/Voice over WiFi) and/or CDMA Femto Base Station Router (BSR). More specifically, wireless user services may be provided in a system including a wireless network interworking server (MFIF) and a wireline supplementary services application server (TAS).

The TAS may include software to interwork with the MFIF. The software may be encoded on some form of program storage medium or implemented over some type of transmission medium.

The MFIF may provide an interface to a wireless network and wireless network specific services, or services that are dynamically driven by data in the wireless network. The TAS provides services that are not specific to the wireless network or wireless user data.

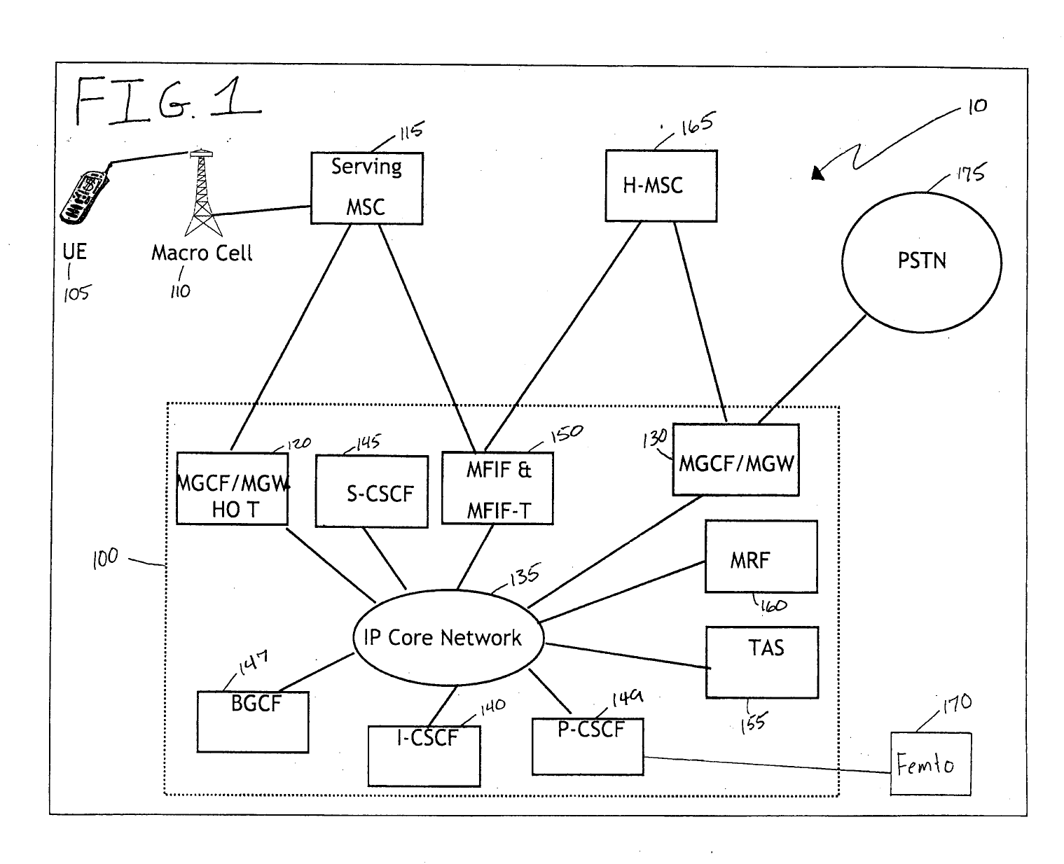

FIG. 1 illustrates a telecommunications system including an IMS network according to an example embodiment. A telecommunications system 10 includes an IMS network 100. The IMS network 100 may be accessed by a user using a user equipment (UE) 105 connected to the IMS network 100 through an access node. In the example shown in FIG. 1, the access node may be a macro cell 110. The macro cell 110 is a CDMA cell that the user is being served on. The UE 105 is a mobile device that is capable of accessing the IMS network 100 via base stations such as a Femto base station or a macro cell such as the macro cell 110.

A serving MSC 115 is a CDMA MSC that the macro cell 110 belongs to.

The serving MSC 115 is connected to a MFIF 150 and a media gateway controller function (MGCF)/media gateway (MGW) for handoff trunks (HOT) 120 for handling a handoff from a Femto 170 to the serving MSC 115. The MGCF/MGW HOT 120 performs protocol conversion between the network protocols used by the serving MSC 115 and the SIP over IP protocols used by the IMS network 100.

The MFIF 150 may receive and process SIP signaling packets and MAP signaling messages in the IMS network 100. The IMS network 100 includes the MGCF/MGW HOT 120, a MGCF/MGW 130, an IP Core Network 135, a serving-CSCF (S-CSCF) 145 and an interrogating-CSCF (I-CSCF) 140, a Breakout Gateway Control Function (BGCF) 147 and a proxy-CSCF (P-CSCF) 149. These well-known IMS elements are further defined in 3GPP TS 23.228 V.8.5.0.

The MGCF/MGW 130 performs protocol conversion between network protocols used by the H-MSC 165 and SIP over IP protocols used by the IMS network 100. The MFIF 150 may be an anchor MSC.

The IMS network 100 further includes the MFIF 150 (a first application server), a TAS 155 (a second application server) and a media resource function (MRF) 160. The MFIF 150 may be a wireless network interworking server or a convergence server. Both the TAS 155 and the MFIF 150 may send and receive signals to and from the S-CSCF 145 via the IP core network 135.

The MRF 160 is connected to the TAS 155 through the IP Core Network 135. The MRF 160 performs media related functions such as producing tones and announcements. Examples of tones and announcements include playing call denial announcements, mapping received SIP error codes into specific denial announcements and playing confirmation announcements after services have been activated or deactivated by the user.

The TAS 155 and the MFIF 150 interact to jointly provide services. More specifically, the MFIF 150 provides an interface to the serving MSC 115 and the TAS 155 is used to provide services that involve call reconfigurations (such as call waiting, three way calling, and call transfer) and connection to the MRF 160 to provide tones and announcements.

The TAS 155 may be configured to provide services assigned to individual users, or may be configured to provide the same set of services to all users attached to the IMS network 100 through the Femto 170. These services are mid-call services such as three way calling, call waiting and call hold. Mid-call services are yes/no types of services without any service data (for example, no forward-to number as in call forwarding type services).

A public switched telephone network (PSTN) 175 is connected to the MGCF/MGW 130. The MGCF/MGW 130 performs protocol conversion between the circuit network protocols used by the PSTN 115 and the IP protocols used by the IMS network 100.

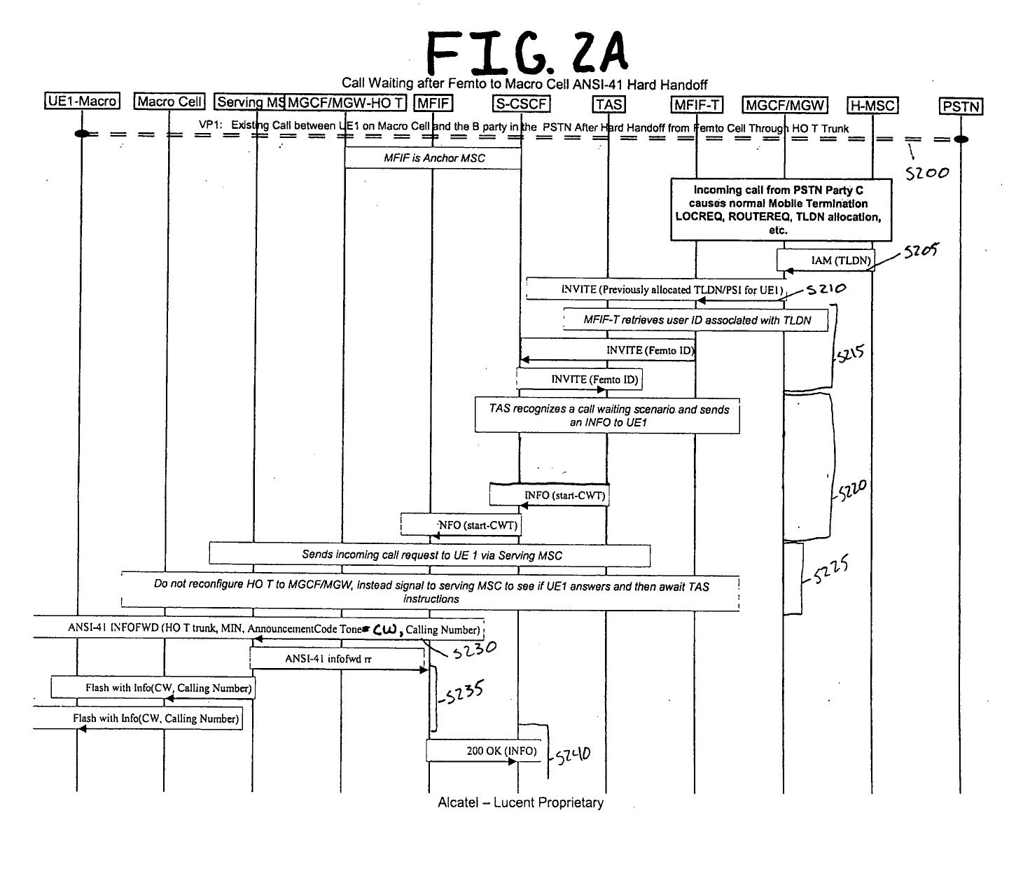

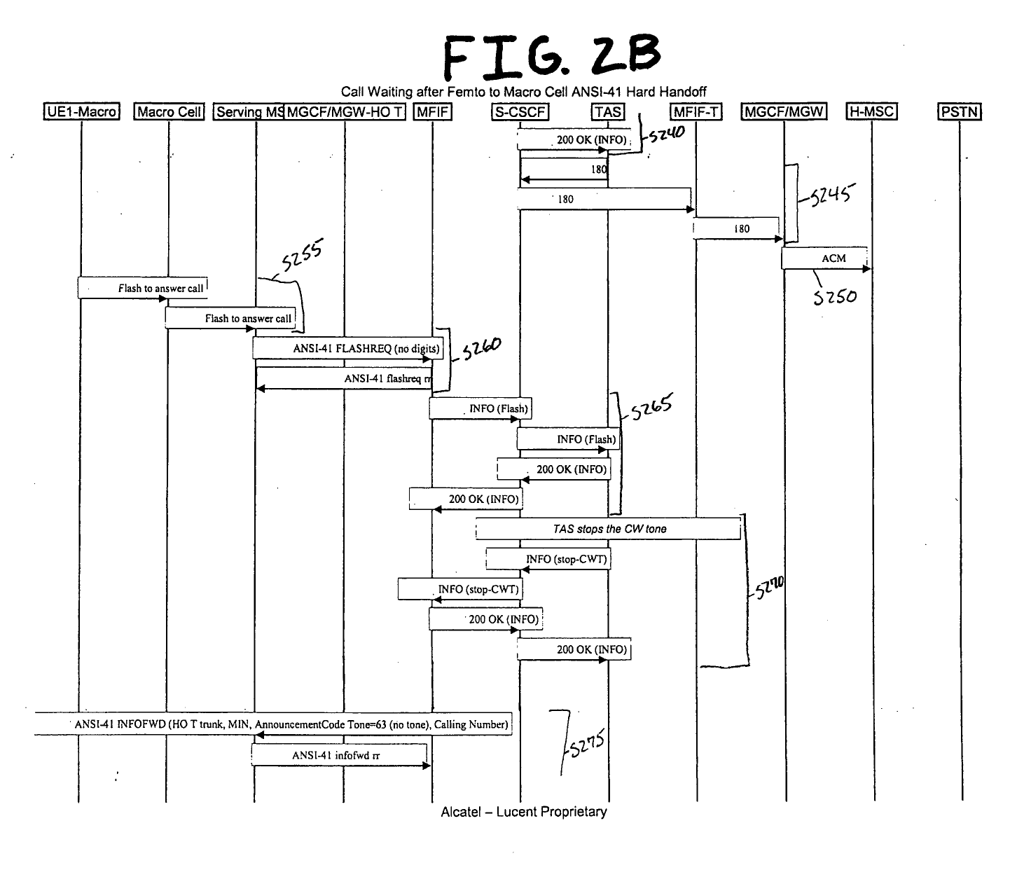

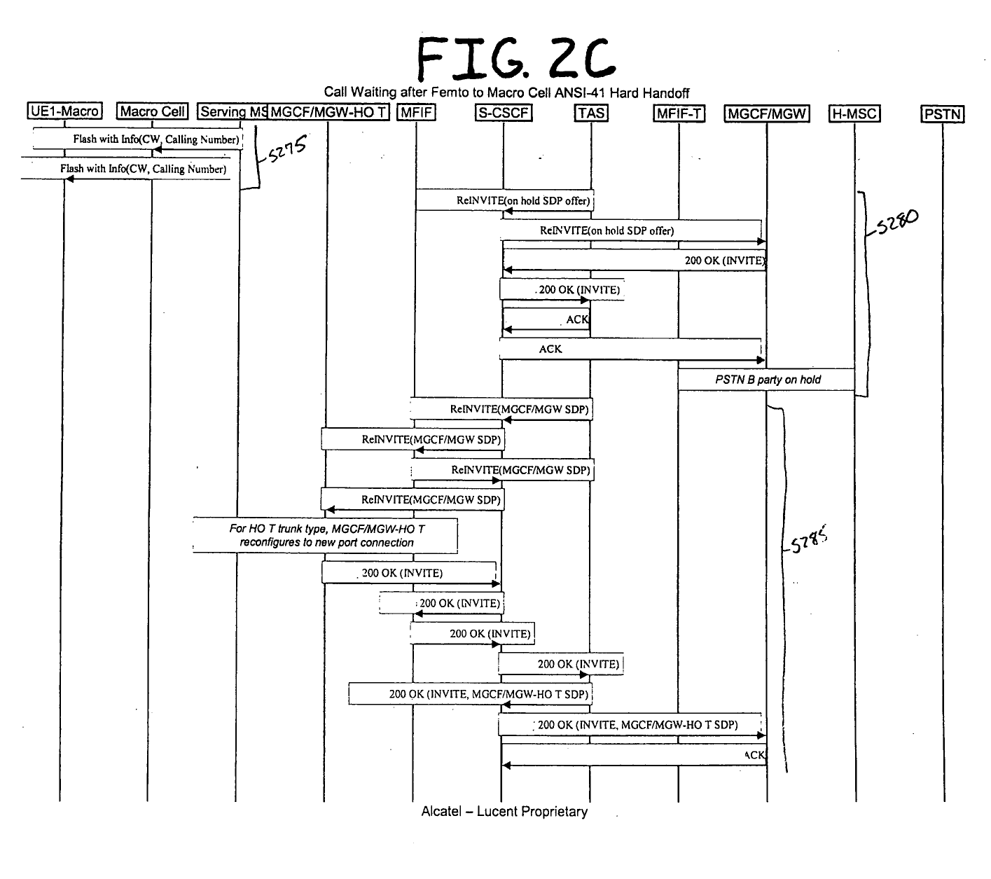

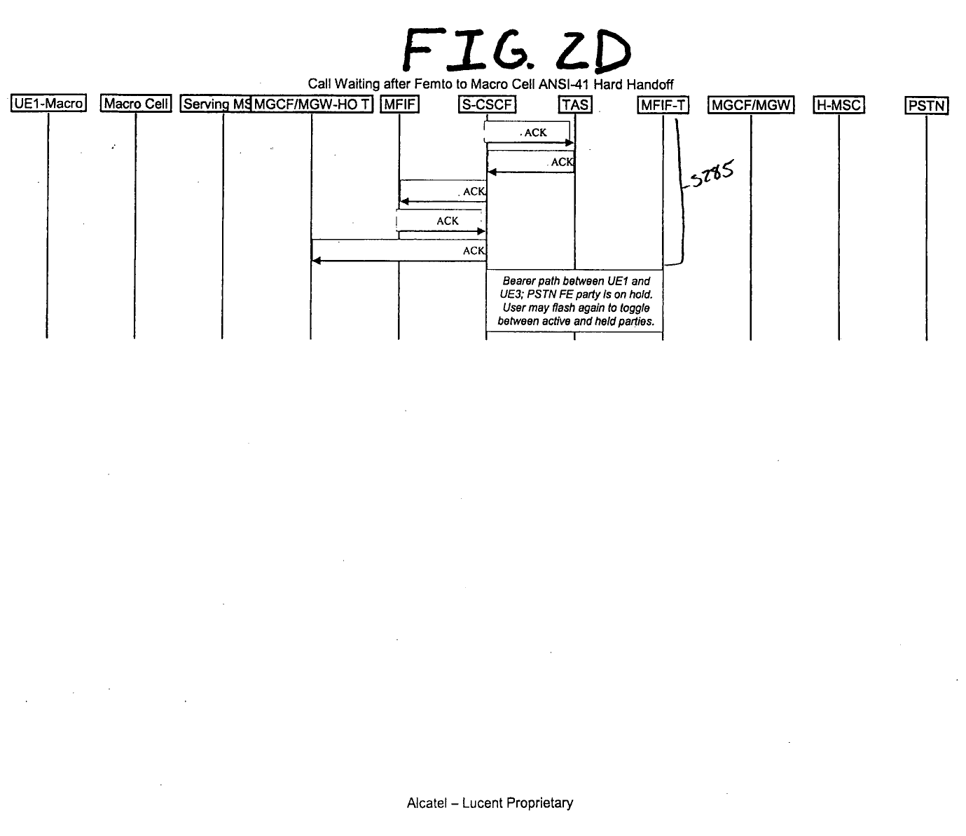

FIGS. 2A-4F illustrate example embodiments. It should be understood that FIGS. 2A-4F may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated circuits, field programmable gate arrays (FPGAs) computers or the like.

FIGS. 2A-2D illustrate an example embodiment of a method of controlling a TAS and a MFIF in a call process in a telecommunications system including an IMS. The method of FIGS. 2A-2D may be implemented by the telecommunications system 10 including the IMS 100. The method of FIGS. 2A-2D may be performed after an ANSI-41 hard handoff of a user from a Femto to a macro cell. ANSI-41, also known as IS-41, is known to one of ordinary skill in the art and therefore, will not be described in detail.

At S200, a call exists between the user on the macro cell (UE1-Macro) and a second party B in a PSTN after the hard handoff from the Femto through a MGCF/MGW HOT on a voice path VP1.

At S205, a call waiting scenario is created when a third party C calls the UE1-Macro. The incoming call from the third party C causes normal Mobile Termination LOCREQ messaging, ROUTEREQ messaging and temporary local directory number (TLDN) allocation to be performed by an H-MSC. LOCREQ, ROUTEREQ and TLDN allocation are well known and therefore, will not be described in more detail.

Since the H-MSC is the originating MSC for the UE1-Macro, an ISUP initial address message (IAM) including the TLDN is sent from the H-MSC to the IMS. More specifically, the IAM is sent to the MGCF/MGW.

At S210, the TLDN is routed from the MGCF/MGW to an MFIF-T in an INVITE message. The MFIF-T then retrieves a user ID associated with the TLDN and sends an INVITE, including a Femto ID associated with the user ID, to a TAS through an S-CSCF at S215. The MFIF manages the association between the user ID and the Femto ID.

For the purpose of illustration, the MFIF-T indicates terminating functions provided by an MFIF before the INVITE is routed to the TAS, while the MFIF provides functions after the TAS has been involved. In other words, terminating messages pass through the MFIF, then through the TAS, then back through the MFIF, and on toward the UE1-Macro. In order to distinguish the MFIF functions that occur before the TAS is involved, the MFIF-T notation is used. In practice, there may be one physical MFIF device involved.

At S220, when the TAS receives the INVITE, the TAS determines that the UE1-Macro is already engaged in a call and that the UE1-Macro has subscribed to call waiting service, so a call waiting scenario exists and the TAS sends an SIP INFO message to the MFIF. The SIP INFO message includes a start call waiting tone command (start-CWT).

The TAS is able to determine a call waiting scenario because the TAS knows that a call exists between the UE1-Macro and the second party B. While only an SIP INFO message is shown, one should understand that other SIP messages used to support TAS based Call Waiting may be used.

At S225, the MFIF receives the SIP INFO message with the start-CWT. The MFIF is the anchor MSC and thus, manages the handoff from the Femto to the macro cell and knows that the UE1-Macro has been handed over from the Femto to the macro cell. Therefore, any supplementary services signaling to or from the UE1-Macro go over a handover link (the ANSI-41 link between the MFIF and the Serving MSC). Since the MFIF knows that the UE1-Macro has been handed over, the MFIF does not forward the SIP message to the Femto. Instead, the MFIF translates the SIP INFO message and generates an ANSI-41 INFOFWD message. For the conversion from SIP to ANSI-41 messaging, the MFIF is aware of the handoff status of the UE1-Macro, as well as the current serving MSC. The mapping between the SIP and ANSI-41 messages includes interpreting an action requested by the TAS or UE1-Macro and translating to the correct ANSI-41 message with parameter values, and vice versa. For example, the ANSI-41 INFOFWD message identifies which call the message is for, which trunk the call is on (HOT), the mobile identity number (MIN), a code to be played (e.g., AnnouncementCode Tone=CW) and the calling number from the third party C.

The ANSI-41 INFOFWD message is sent to a serving MSC at S230. The serving MSC is the MSC that the UE1-Macro has been handed over to.

At S235, the serving MSC sends an ANSI-41 infofwd rr confirmation back to the MFIF and flashes to the macro cell. The flash is forwarded by the macro cell to the UE1-Macro with the calling number information. The call information includes a flash indication and the calling number of the third party C.

The MFIF responds to the SIP INFO message received at S220 by sending a 200 OK message to the S-CSCF and from the S-CSCF to the TAS, at S240. The TAS then sends a 180 response to the S-CSCF. The S-CSCF sends the 180 response to the MFIF-T, which then forwards the 180 response to the MGCF/MGW, at S245. At S250, an ACM message is sent from the MGCF/MGW to the H-MSC. The ACM message is a response to the ISUP IAM message. The 200 OK, 180 and ACM messages are well known and therefore, will not be described in greater detail for the sake of clarity and brevity.

At S255, the UE1-Macro decides to accept the call from the third party C by flashing to answer the call from the third party C. The flash is sent from the macro cell to the serving MSC. While FIG. 2B illustrates that the UE1-Macro accepts the call from the third party C, one should understand that the UE1-Macro may decide not to accept the call from the third party C.

The serving MSC translates the received flash into an ANSI-41 FLASHREQ message, at S260, and sends the ANSI-41 FLASHREQ message to the MFIF. The MFIF responds by sending a confirmation ANSI-41 flashreq rr confirmation to the serving MSC.

At S265, the MFIF translates the ANSI-41 FLASHREQ message into an SIP INFO message. The MFIF performs the translation into the SIP INFO message so that the TAS will be able to understand that the UE1-Macro wants to accept the call from the third party C. The MFIF sends the SIP INFO message to the S-CSCF, which sends the SIP INFO message to the TAS. The SIP INFO message identifies that the UE1-Macro has flashed. The TAS responds to the SIP INFO message by sending a 200 OK message to the S-CSCF, which sends the 200 OK message to the MFIF.

At S270, the TAS stops the CWT and sends an SIP INFO message indicating that the CWT has been stopped to the S-CSCF. The S-CSCF sends the SIP INFO message to the MFIF. The MFIF then acknowledges that the MFIF has received the SIP INFO message by sending a 200 OK message to the S-CSCF, which sends the 200 OK message to the TAS.

At S275, the MFIF sends a request to turn off the call waiting tone. More specifically, the MFIF generates an ANSI-41 INFOFWD message including the HOT, MIN, an announcement code (e.g., no Lone) and the calling number of the third party.

The MFIF sends the ANSI-41 INFOFWD message to the serving MSC. The serving MSC confirms receipt by sending an ANSI-41 infofwd rr message to the MFIF. The serving MSC also translates the ANSI-41 INFOFWD message into a Flash with Info and sends the Flash with Info to the macro cell. The macro cell then forwards the Flash with Info to the UE1-Macro.

While the TAS is sending out a message indicating that the CWT has stopped, the TAS puts the second party B on hold at S280. More specifically, the TAS places the second party B on hold with standard SIP REINVITE procedures. The TAS sends to the S-CSCF a SIP REINVITE, including an on hold Session Description Protocol (SDP) offer, to the S-CSCF. The S-CSCF forwards the SIP REINVITE to the MGCF/MGW. The MGCF/MGW responds by sending a 200 OK acknowledgement with an INVITE to the S-CSCF. The S-CSCF forwards the 200 OK acknowledgment to the TAS. An ACK acknowledgment is then sent from the TAS to the S-CSCF and from the S-CSCF to the MGCF/MGW.

At S285, the call is reconfigured to establish a bearer path in the IMS between the UE1-Macro and the third user C. A REINVITE including an MGCF/MGW SDP is sent from the TAS to the S-CSCF, from the S-CSCF to the MFIF, from the MFIF to the S-CSCF and from the S-CSCF to the MGCF/MGW HOT.

The MGCF/MGW reconfigures the HOT to a port connection for the third party C. A 200 OK acknowledgement including an INVITE is sent from the MGCF/MGW-HOT to the S-CSCF, from the S-CSCF to the MFIF, from the MFIF to the S-CSCF and from the S-CSCF to the TAS.

The TAS adds a MGCF/MGW-HOT SDP to the 200 OK acknowledgment and sends the 200 OK acknowledgment to the S-CSCF, which forwards the 200 OK acknowledgment to the MGCF/MGW. An ACK acknowledgment is sent from the MGCF/MGW to the S-CSCF, from the S-CSCF to the TAS, from the TAS to the S-CSCF, from the S-CSCF to the MFIF, from the MFIF to the S-CSCF and from the S-CSCF to the MGCF/MGW-HOT.

The UE1-Macro may flash again to toggle between active and held parties (e.g., second party B and third party C).

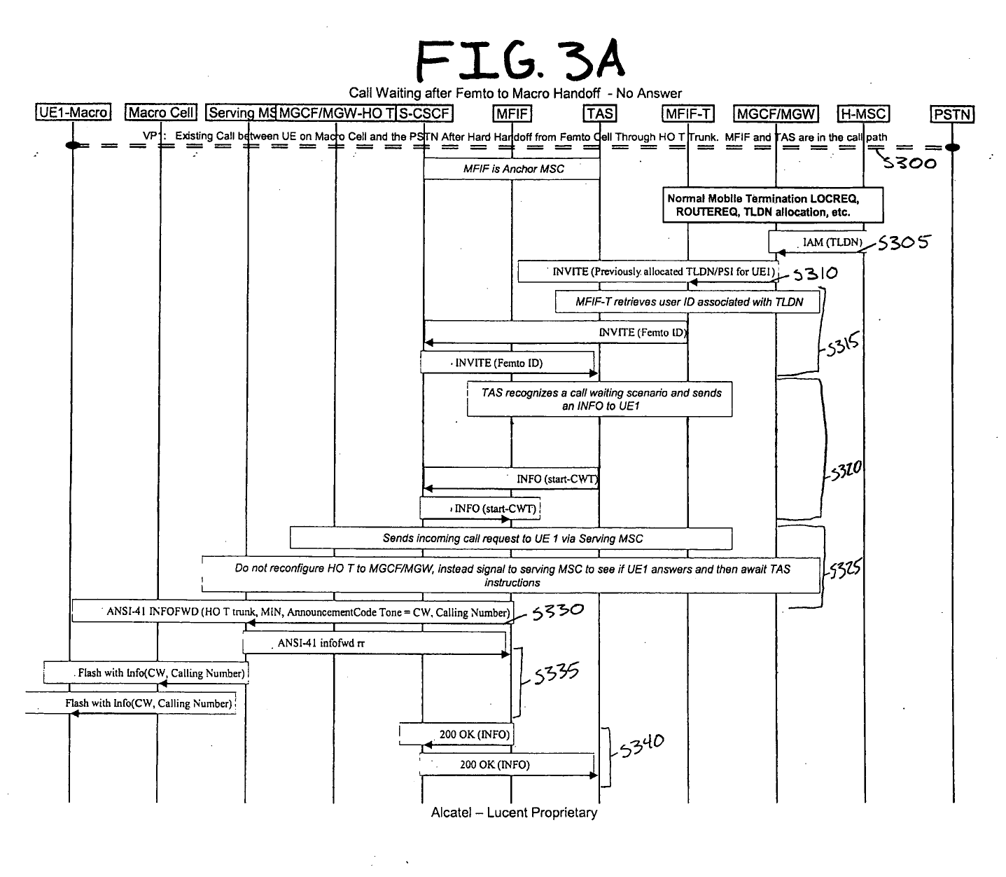

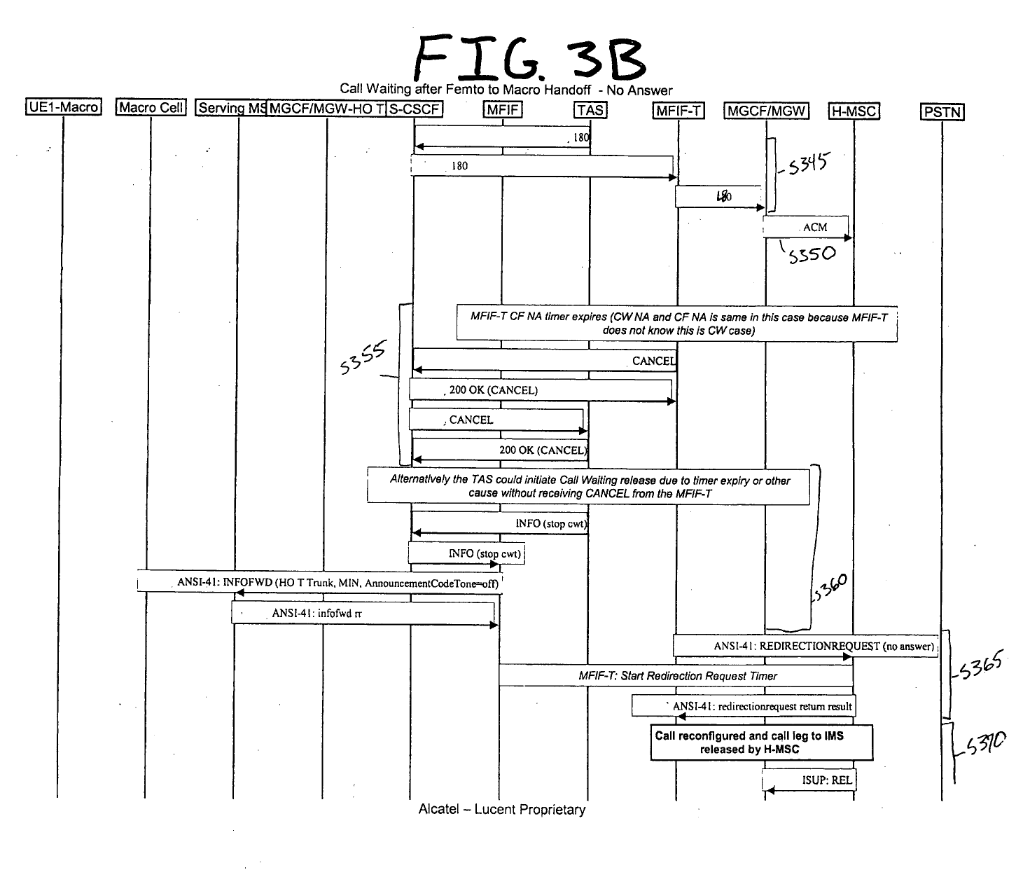

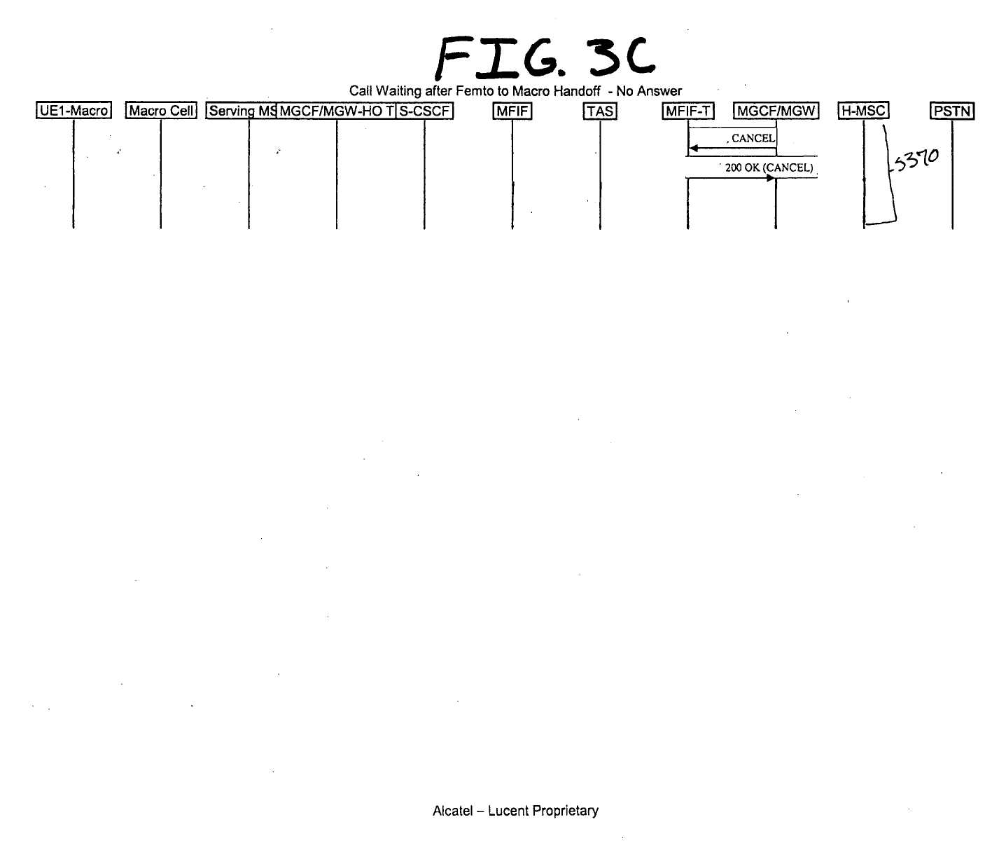

FIGS. 3A-3C illustrate another example embodiment of a method of controlling a TAS and a MFIF in a call process in a telecommunications system including an IMS. The method of FIGS. 3A-3C may be implemented by the telecommunications system 10 including the IMS 100. The method of FIGS. 3A-3C may be performed after an ANSI-41 hard handoff of a user (UE1-Macro) from a Femto to a macro cell.

At S300, a call exists between the UE1-Macro on the macro cell and a second party B on a PSTN after a hard handoff from a Femto cell through a HOT on a voice path VP1. A MFIF and TAS are in the call path.

Steps S305-S350 are the same as steps S205-S250. Therefore, for the sake of clarity and brevity, S305-S350 will not be described in more detail.

In FIGS. 3A-3C, there is no flash request back from the UE1-Macro because the UE1-Macro does not answer the Flash with Info from the serving MSC. Therefore, at S355, the MFIF-T call forwarding (CF) no answer (NA) timer expires. The MFIF runs the CFNA timer and the TAS runs the call waiting (CW) no answer (NA) timer. The MFIF-T sends a CANCEL message to the S-CSCF. The S-CSCF sends a 200 OK acknowledgement to the MFIF-T and a CANCEL message to the TAS. The TAS sends a 200 OK acknowledgement to the S-CSCF.

One of ordinary skill should understand that S355 may be performed optionally. The TAS may initiate call waiting release without receiving the CANCEL message from the MFIF-T due to the CW NA timer expiration.

At S360, the TAS sends an SIP INFO message with stop CWT to the S-CSCF. The S-CSCF forwards the SIP INFO message to the MFIF. Based on the received SIP INFO message, the MFIF generates an ANSI-41 INFOFWD message including the HOT, the MIN, and an announcement code tone and sends the ANSI-41 INFOFWD message to the serving MSC. The announcement code tone equals off. The serving MSC responds to the ANSI-41 INFOFWD by sending an ANSI-41 infofwd rr to the MFIF.

Upon receipt of the infofwd rr, the MFIF-T sends an ANSI-41 REDIRECITIONREQUEST message to the H-MSC indicating a no answer scenario (i.e., the UE1-Macro did not respond to the Flash with Info), at S365. When the MFIF-T sends the ANSI-41 REDIRECTIONREQUEST message, the MFIF-T starts a redirection request timer. If the H-MSC does not respond during a given time, the MFIF will attempt to retrieve the forward to number from the HLR and forward the call itself. The H-MSC responds to the REDIRECTIONREQUEST message with a ANSI-41 return result.

At S370, the call is reconfigured and the call leg from the third party C to the IMS is released by the H-MSC. More specifically, the H-MSC sends a ISUP REL message to the MGCF/MGW. The MGCF/MGW then sends a CANCEL message to the MFIF-T, which acknowledges receipt of the CANCEL message by sending a 200 OK acknowledgment to the MGCF/MGW. The MFIF knows to stop the CANCEL message because the call was released.

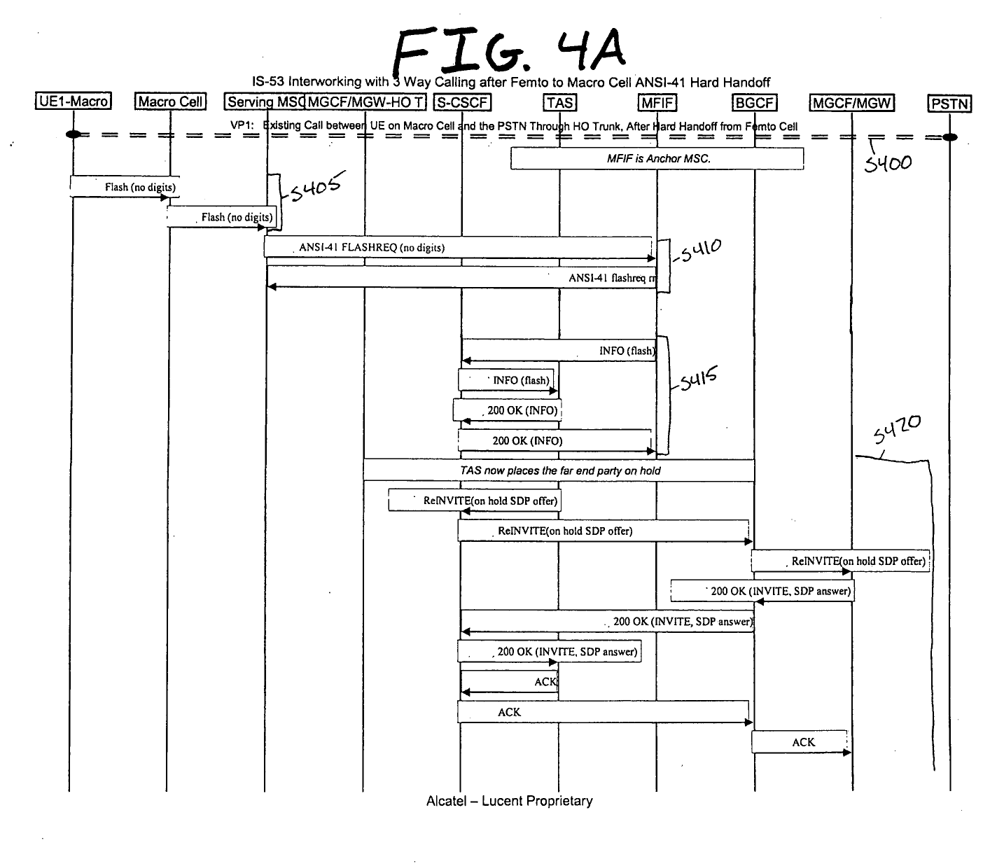

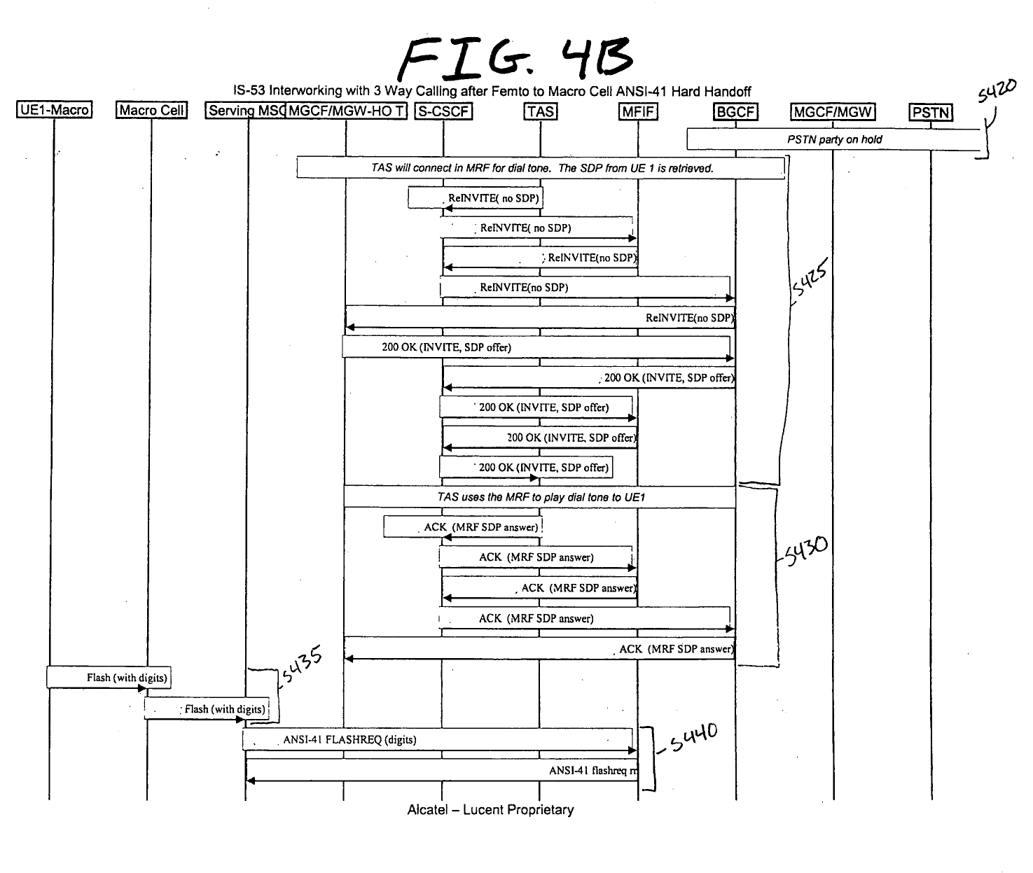

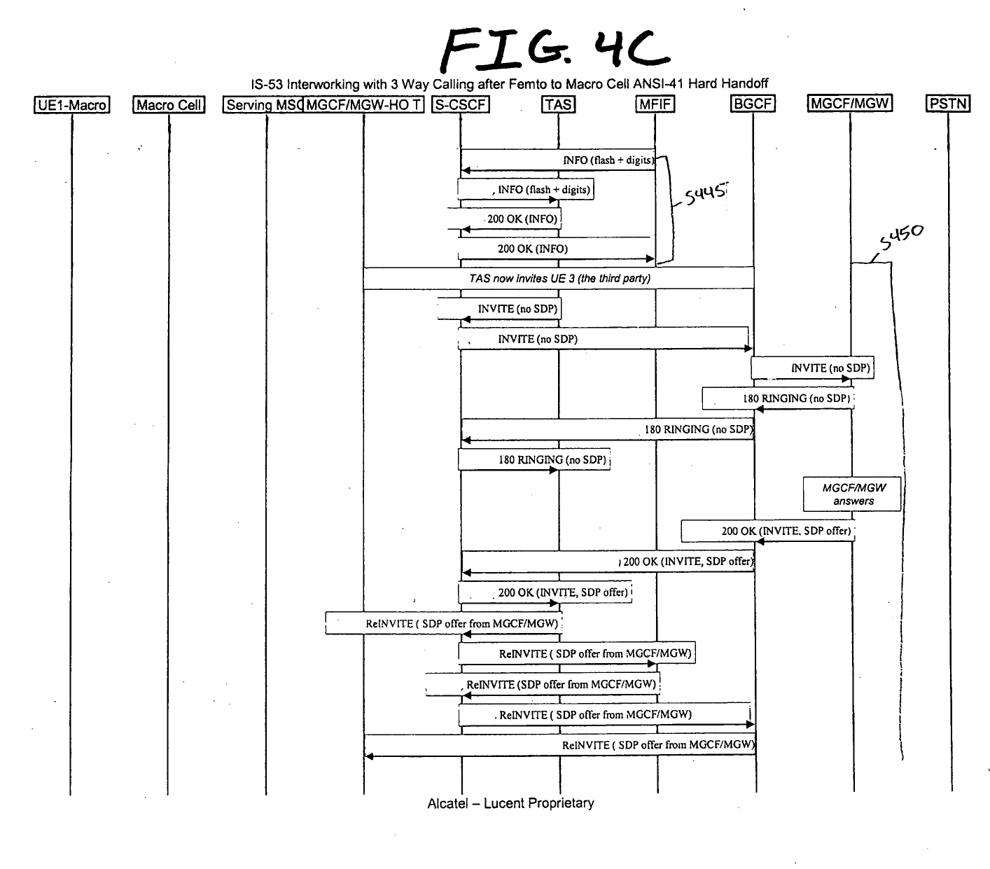

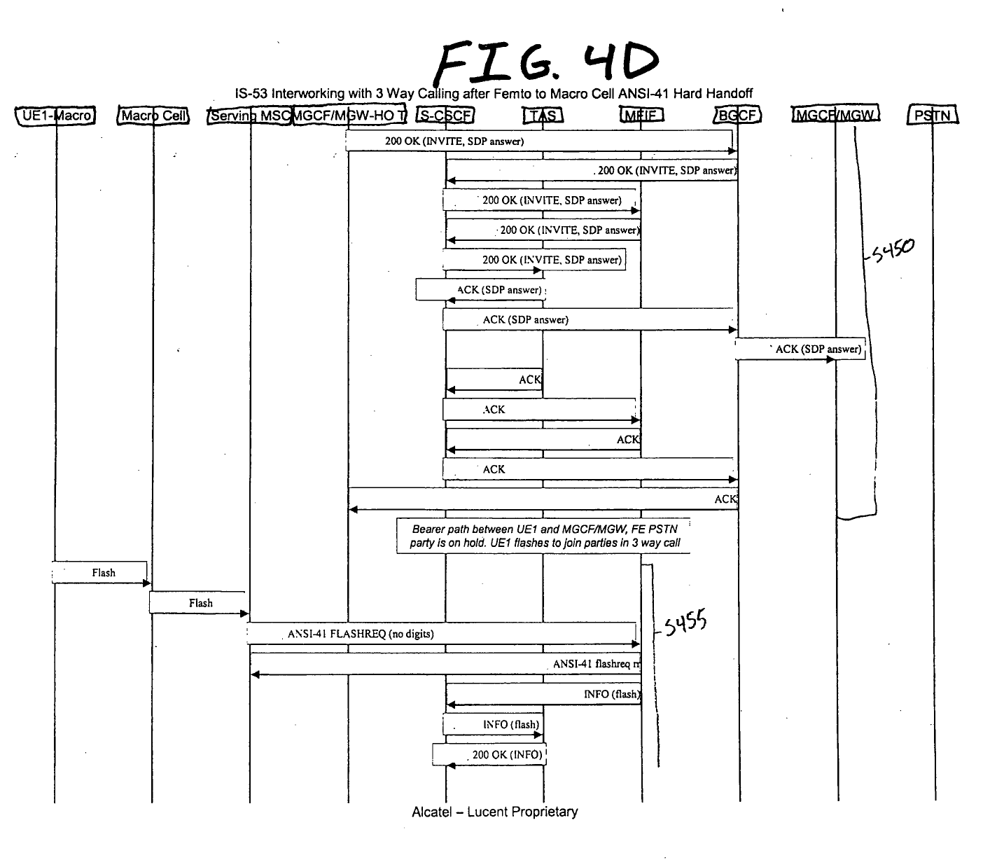

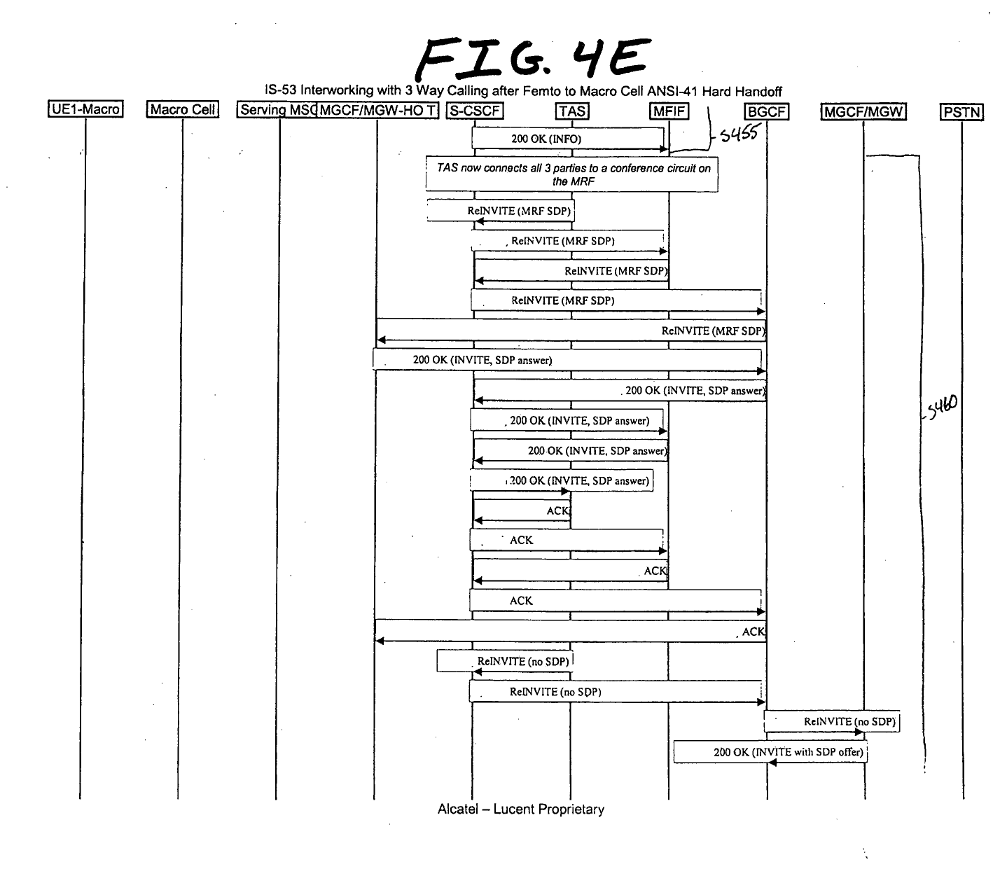

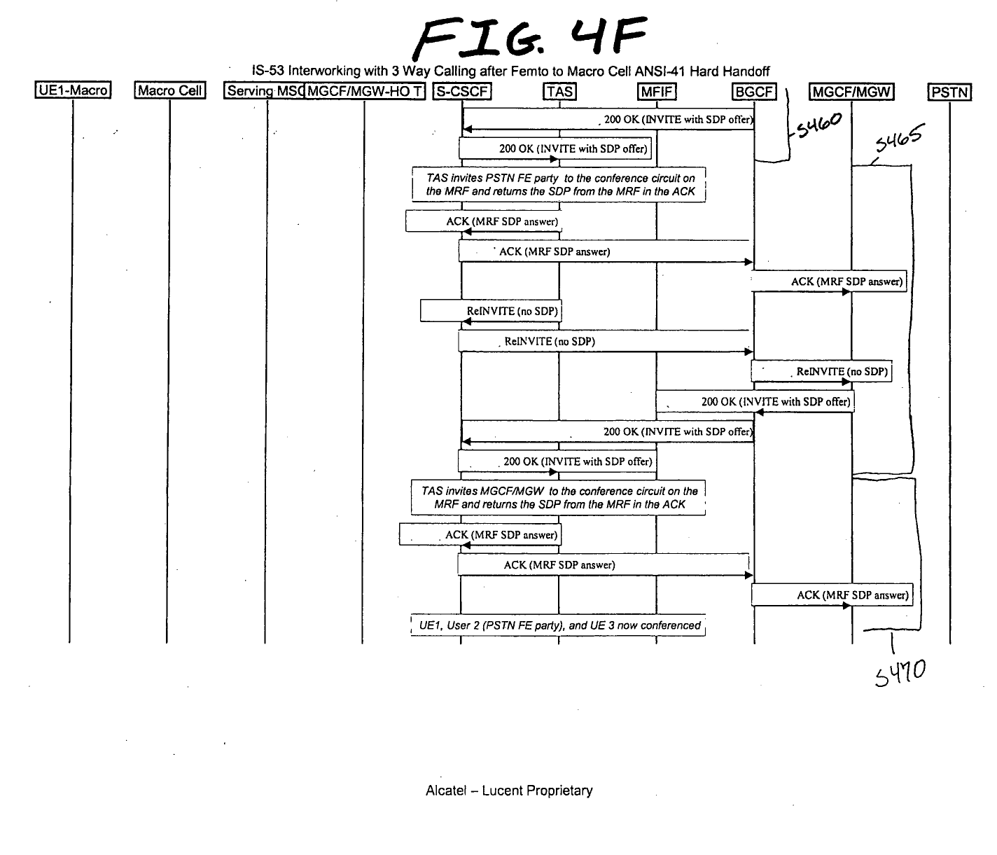

FIGS. 4A-4F illustrate an example embodiment of a method of controlling a MFIF and a TAS in an IMS during three way calling. More specifically, FIGS. 4A-4F illustrate an example embodiment of IS-53 interworking with three way calling after a Femto to macro cell ANSI-41 hard handoff. IS-53 is well known and therefore, will not be described in greater detail for the sake of clarity and brevity.

The method of FIGS. 4A-4F may be implemented by the telecommunications system 10 including the IMS 100.

At S400, a call exists between the UE1-Macro on the macro cell and a second party B in a PSTN after a hard handoff from a Femto cell through a HOT on a voice path VP1. As shown in FIG. 4A, a MFIF is an anchor MSC.

When a user on UE1-Macro presses the “flash”, “talk”, or “send” button on the mobile device and then dials digits (the specific sequence of key presses may vary based on the particular mobile device), the device sends a “flash” message to the macro cell at S405. This initiates the three way calling by flashing a macro cell, which forwards the flash to a serving MSC. The serving MSC generates an ANSI-41 FLASHREQ message and sends the ANSI-41 FLASHREQ message to the MFIF, which acknowledges receipt of the ANSI-41 FLASHREQ message by sending an ANSI-41 flashreq rr message back to the serving MSC at S410.

The MFIF translates the ANSI-41 FLASHREQ to an SIP INFO message, at S415. The MFIF sends the SIP INFO message to a TAS through the S-CSCF. The TAS then sends a 200 OK acknowledgement to the MFIF through the S-CSCF.

Since the TAS knows that a call exists between the UE1-Macro and the second party B, the TAS knows that the UE1-Macro wishes to set up a three way call when the TAS receives the SIP INFO message that contains the flash. Upon receipt of the SIP INFO message, the TAS places the second party B on hold with standard SIP REINVITE procedures, at S420. The TAS sends a REINVITE that contains an on hold SDP to a Breakout Gateway Control Function (BGCF) through the S-CSCF. The BGCF sends the REINVITE to the MGCF/MGW.

A 200 OK acknowledgement that contains an INVITE message and an SDP answer is sent from the MGCF/MGW to the BGCF, from the BGCF to the S-CSCF and from the S-CSCF to the TAS. The TAS then sends an ACK message to the S-CSCF, from the S-CSCF to the BGCF and from the BGCF to the MGCF/MGW. When the MGCF/MGW receives the ACK message, the second party B is on hold.

At S425, the TAS connects to the MRF, including a tone generator, to produce a dial tone for the UE1-Macro. A REINVITE with no SDP is sent from the TAS to the S-CSCF, from the S-CSCF to the MFIF, from the MFIF to the S-CSCF, from the S-CSCF to the BGCF and from the BGCF to the MGCF/MGW-HOT.

The MGCF/MGW-HOT generates and sends a 200 OK message including an INVITE message and SDP offer to the BGCF. The 200 OK message is sent from the BGCF to the S-CSCF, from the S-CSCF to the MFIF, from the MFIF to the S-CSCF and from the S-CSCF to the TAS.

Once the TAS connects to the MRF, the TAS uses the MRF to play the dial tone to the UE1-Macro, at S430. The TAS sends an ACK message with an MRF SDP answer to the S-CSCF. The ACK message is then sent from the S-CSCF to the MFIF, from the MFIF to the S-CSCF, from the S-CSCF to the BGCF and from the BGCF to the MGCF/MGW-HOT.

When the UE1-Macro receives the dial tone, the UE1-Macro flashes with digits of a third party UE3 to be connected to the three way calling, at S435. The flash is sent from the UE1-Macro to the macro cell and from the macro cell to the serving MSC.

At S440, the serving MSC generates an ANSI-41 FLASHREQ, with digits of the third party UE3, based on the flash message received from the macro cell. The serving MSC sends the ANSI-41 FLASHREQ message to the MFIF and the MFIF responds by sending an ANSI-41 flashreq rr back to the serving MSC.

The MFIF translates the ANSI-41 FLASHREQ message into an SIP INFO message containing the flash and digits of the third party UE3, at S445. The SIP INFO message is sent from the MFIF to the TAS, through the S-CSCF. A 200 OK message containing the SIP INFO message is sent to the MFIF through the S-CSCF.

At S450, the TAS invites the third party UE3 and establishes a bearer path between the UE1-Macro and the MGCF/MGW that is connected to the third party UE3. An invite is generated and sent by the TAS to the S-CSCF, from the S-CSCF to the BGCF and from the BGCF to the MGCF/MGW. The TAS initiates a call out to the third party UE3. The TAS sends an INVITE message with no SDP to the S-CSCF. The INVITE message is sent from the S-CSCF to the BGCF and from the BGCF to the MGCF/MGW.

The MGCF/MGW generates a 180 RINGING message in response to the received INVITE message. The 180 RINGING message is sent from the MGCF/MGW to the BGCF, from the BGCF to the S-CSCF and from the S-CSCF to the TAS.

When the MGCF/MGW answers the INVITE, a 200 OK message including the SDP offer is sent from the MGCF/MGW to the BGCF, from the BGCF to the S-CSCF and from the S-CSCF to the TAS.

The TAS then generates a REINVITE including the SDP offer from the MGCF/MGW. The REINVITE is sent from the TAS to the S-CSCF, from the S-CSCF to the MFIF, from the MFIF to the S-CSCF, from the S-CSCF to the BGCF and from the BGCF to the MGCF/MGW-HOT.

The MGCF/MGW-HOT generates a 200 OK message, including an INVITE and an SDP answer, in response to the received REINVITE. The 200 OK message is sent from the MGCF/MGW-HOT to the BGCF, from the BGCF to the S-CSCF, from the S-CSCF to the MFIF, from the MFIF to the S-CSCF and from the S-CSCF to the TAS.

Upon receipt of the 200 OK message, an ACK message is then sent from the TAS to the S-CSCF, from the S-CSCF to the BGCF and from the BGCF to the MGCF/MGW.

An ACK message is sent from the TAS to the S-CSCF, from the S-CSCF to the MFIF, from the MFIF to the S-CSCF, from the S-CSCF to the BGCF and from the BGCF to the MGCF/MGW-HOT. The ACK message sent from the TAS to the MFIF (through the S-CSCF) may be sent at the same time the another ACK message is sent from the TAS to the BGCF (through the S-CSCF).

At S455, the UE1-Macro flashes to join the second party B and the third party UE3 in a three way call. The UE1 flashes to the macro cell, which forwards the flash to the serving MSC. The serving MSC translates the flash into an ANSI-41 FLASHREQ with no digits. The serving MSC send the ANSI-41 FLASHREQ to the MFIF, which sends an ANSI-41 flashreq rr back to the serving MSC.

The MFIF generates an SIP INFO message with a flash based on the received ANSI-41 FLASHREQ message. The SIP INFO message is sent from the MFIF to the S-CSCF and from the S-CSCF to the TAS. When the TAS receives the SIP INFO message, the TAS sends a 200 OK message to the S-CSCF, which sends the 200 OK message to the MFIF.

At S460, the TAS connects the UE1-Macro, the second party B and the third party UE3 to a conference circuit on the MRF. More specifically, the TAS generates a REINVITE containing an MRF SDP. The REINVITE is sent from the TAS to the S-CSCF, from the S-CSCF to MFIF, from the MFIF to the S-CSCF, from the S-CSCF to the BGCF and from the BGCF to the MGCF/MGW-HOT.

In response to the REINVITE, the MGCF/MGW-HOT generates a 200 OK message containing the INVITE and an SDP answer. The 200 OK message is sent from the MGCF/MGW-HOT to the BGCF, from the BGCF to the S-CSCF, from the S-CSCF to the MFIF, from the MFIF to the S-CSCF and from the S-CSCF to the TAS. An ACK message is then sent from the TAS to the S-CSCF, from the S-CSCF to the MFIF, from the MFIF to the S-CSCF, from the S-CSCF to the BGCF and from the BGCF to the MGCF/MGW-HOT.

The TAS also generates a REINVITE and sends the REINVITE to the MGCF/MGW through the S-CSCF and BGCF.

The MGCF/MGW generates a 200 OK message containing the INVITE and an SDP offer. The 200 OK message is sent from the MGCF/MGW to the BGCF, from the BGCF to the S-CSCF and from the S-CSCF to the TAS.

At S465, the TAS invites the second party B to the conference circuit on the MRF and returns the SDP from the MRF in an ACK message. The TAS sends and ACK message containing the MRF SDP answer to the MGCF/MGW through the S-CSCF and the BGCF. The TAS also sends a REINVITE with no SDP to the MGCF/MGW through the S-CSCF and the BGCF.

Based on the received REINVITE message, the MGCF/MGW generates a 200 OK message containing an INVITE with an SDP offer. The 200 OK message is sent from the MGCF/MGW to the BGCF, from the BGCF to the S-CSCF and from the S-CSCF to the TAS.

At S470, the TAS invites the MGCF/MGW to the conference circuit on the MRF and returns the SDP from the MRF in the ACK. The TAS sends the ACK message with the MRF SDP answer to the MGCF/MGW through the S-CSCF and the BGCF. The UE1-Macro, second party B and third party UE3 become conferenced in the three way call.

Example embodiments being thus described, it will be obvious that the example embodiments be varied in many ways. The above-disclosed subject matter is to be considered illustrative, and not restrictive, and the appended claims are intended to cover all such modifications, enhancements, and other embodiments, which fall within the spirit and scope of the example embodiments. Such variations are not to be regarded as a departure from the spirit and scope of the example embodiments, and all such variations are intended to be included within the scope of the claims.

What is claimed is:

1. A system for providing wireless services to a first user on the system after a handoff from a first mobile switching center to a second mobile switching center, the system comprising:
a first application server configured to provide wireless services and coupled to the second mobile switching center, the second mobile switching center serving the first user; and
a second application server configured to provide wireline services, the first application server being further configured to interact with the second application server to provide the wireless and wireline services to the first user.

2. The system of claim 1, wherein the first application server is an anchor mobile switching center that controls wireless and wireline services and calls to and from the first user.

3. The system of claim 1, wherein the first application server is configured to receive a call request from a third user during an existing call between the first user and a second user and transmit an instruction to the second application server to provide a call waiting tone.

4. The system of claim 3, wherein the first application server is configured to translate a call waiting tone instruction from the second application server into an ANSI-41 message to send to the second mobile switching center.

5. The system of claim 4, wherein the first application server is configured to receive an ANSI-41 message, translate the ANSI-41 message into a first protocol message and transmit the first protocol message to the second application server.

6. The system of claim 1, wherein the second application server is configured to receive a request from the first user to make a second call during a first call between the first user and a second user and transmit an instruction to a media resource function to place the first call on hold based on the request.

7. A method of providing wireless services to a first user on a system after a handoff from a first mobile switching center to a second mobile switching center, the method comprising:
first receiving, at a first application server, a call request from the first mobile switching center, the call request being initiated by a third user during an existing call between the first user and a second user;
first transmitting, by the first application server, to a second application server an invite to answer the call request from the third user;
second receiving, at the first application server, a first protocol message from the second application server, the first protocol message being based on the invite; and
second transmitting, by the first application server, a second protocol message to the first user, the second protocol being different than the first protocol.

8. The method of claim 7, wherein the second receiving includes,
receiving a session initiation protocol (SIP) message, the SIP being the first protocol.

9. The method of claim 8, wherein the second transmitting includes,
transmitting an ANSI-41 message based on the received SIP message, the ASNI-41 being the second protocol.

10. The method of claim 9, wherein the second transmitting includes,
transmitting the ANSI-41 message to the second mobile switching center, the second mobile switching being configured to transmit the call request to the first user based on the ANSI-41 message.

11. The method of claim 7, wherein the first receiving includes,
receiving a temporary routing number associated with the call request.

12. The method of claim 7, wherein the second transmitting includes,
transmitting the second protocol message to the second mobile switching center, the second mobile switching being configured to transmit the call request to the first user based on the second protocol message.

13. The method of claim 7, wherein the second receiving includes,
receiving the first protocol message indicating that a call waiting tone is started.

14. The method of claim 13, further comprising:
third receiving, at the first application server, a flash signal from the first user to answer the call request from the third user.

15. The method of claim 14, wherein the third receiving includes,
receiving a signal from the second application server indicating that the call waiting tone is terminated.

16. A method of providing wireless services to a first user on a system after a handoff from a first mobile switching center to a second mobile switching center, the method comprising:
first receiving, at the first application server, a first protocol message including a call request from the second mobile switching center during an existing call between the first user and a second user, the call request being initiated by the first user;
first transmitting, by the first application server, a second protocol message including the call request to a second application server, the second protocol being different than the first protocol;
second receiving, by the first application server, a second protocol acknowledgment message from the second application server, the second protocol acknowledgment message indicating that that the second user is on hold; and
second transmitting, by the first application server, a second first protocol message to the second application server, the second first protocol message including an identification of a third user to be connected to the first user.

17. The method of claim 16, further comprising:
third receiving, at the first application server, a second first protocol message from the first user to request a connection with the third user.

18. The method of claim 17, further comprising:
fourth receiving, at the first application server, a second second protocol message from the second application server, the second second protocol message based on the second first protocol message.
